(19) United States
(12) Patent Application Publication
(10) Pub. No.: US 2021/0108402 A1
(43) Pub. Date: Apr. 15, 2021

(54) TOILET REMOTE CONTROLLER

(71) Applicant: LIXIL Corporation, Tokyo (JP)

(72) Inventors: Ryuhei YAMASAKI, Tokyo (JP); Hideyuki AKASAKI, Tokyo (JP); Nobuyasu MIZUNO, Tokyo (JP); Keiko NAKAGAWA, Tokyo (JP); Tomokazu TOYA, Tokyo (JP)

(73) Assignee: LIXIL Corporation, Tokyo (JP)

(21) Appl. No.: 17/028,703

(22) Filed: Sep. 22, 2020

(30) Foreign Application Priority Data
Oct. 15, 2019 (JP) 2019-188363

(51) Int. Cl. E03D 5/10

(52) U.S. Cl. CPC E03D 5/10; G08C 17/02

(57) ABSTRACT

A toilet remote controller includes a main body, an electrostatic switch provided on a front surface of the main body, and a control unit that is provided in the main body and transmits an operation signal corresponding to an operation of the electrostatic switch to a toilet device.

### CROSS-REFERENCE TO RELATED APPLICATIONS

This application claims the priority of Japanese Application No. 2019-188363, filed Oct. 15, 2019, the entire contents of which are incorporated herein by reference.

### FIELD OF THE DISCLOSURE

The present disclosure relates to a toilet remote controller.

### BACKGROUND OF THE DISCLOSURE

Conventionally, a toilet remote controller for remotely operating a toilet device is known. For example, a main body of a toilet remote controller described in JP 2011-84867A is provided with circular switches as an operation unit. For example, a bidet function of a toilet device is activated when a user presses one of the circular switches, and a shower function of the toilet device is activated when the user presses another of the circular switches.

### SUMMARY OF THE DISCLOSURE

In known toilet remote controllers as described above, irregularities of the switches are formed on the operation surface of the main body. For this reason, it has been difficult to improve the design of the main body.

The present disclosure may address the above situations, and one advantage of the present disclosure is to provide a toilet remote controller that can improve the design of a main body.

A toilet remote controller according to the present disclosure may include, in some embodiments: a main body; an electrostatic switch provided on a front surface of the main body; and a control unit that is provided in the main body and configured to transmit an operation signal corresponding to an operation of the electrostatic switch to the toilet device.

### BRIEF DESCRIPTION OF THE FIGURES

FIG. 1 is a perspective view showing a toilet remote controller attached in a toilet room according to some embodiments;

FIG. 2 is a perspective view showing an adapter removed from a main body according to some embodiments;

FIG. 3 is an exploded perspective view showing the main body according to some embodiments;

FIG. 4 is a front view showing the main body according to some embodiments;

FIG. 5 is a rear view showing the main body according to some embodiments;

FIG. 6 is a side view showing the main body according to some embodiments;

FIG. 7 is a side view showing an operation of a first operation unit of the main body;

FIG. 8 is a side view showing an operation of a second operation unit of the main body according to some embodiments;

FIG. 9 is an enlarged view showing a part of the first operation unit of the main body in an enlarged manner according to some embodiments; and

FIG. 10 is a perspective view showing a toilet remote controller with the main body removed from a holder according to some embodiments.

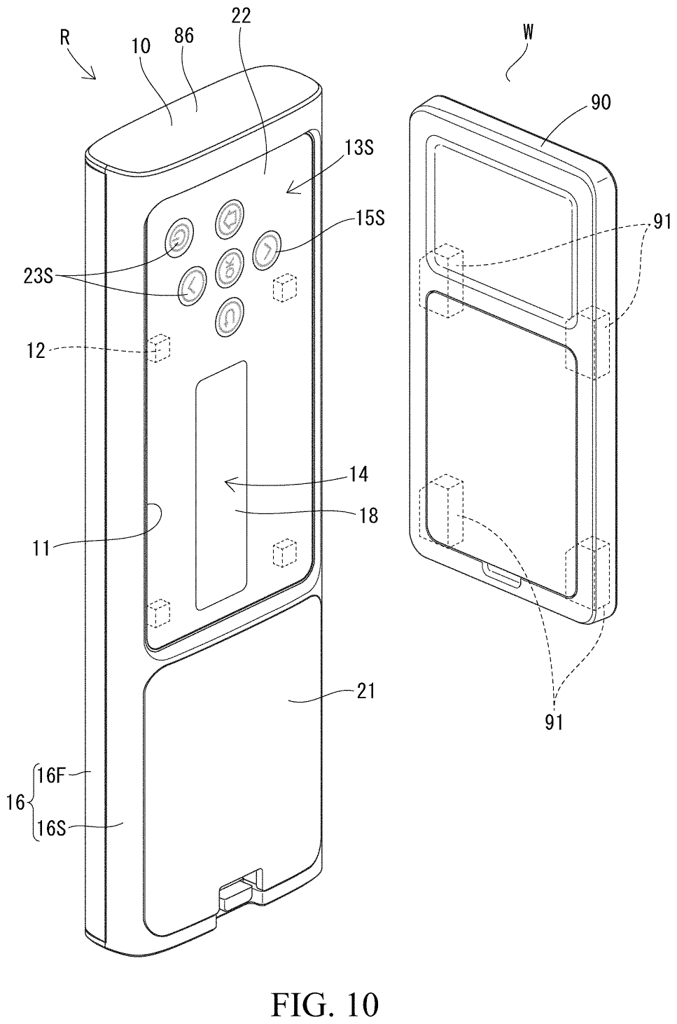

### DETAILED DESCRIPTION OF THE DISCLOSURE

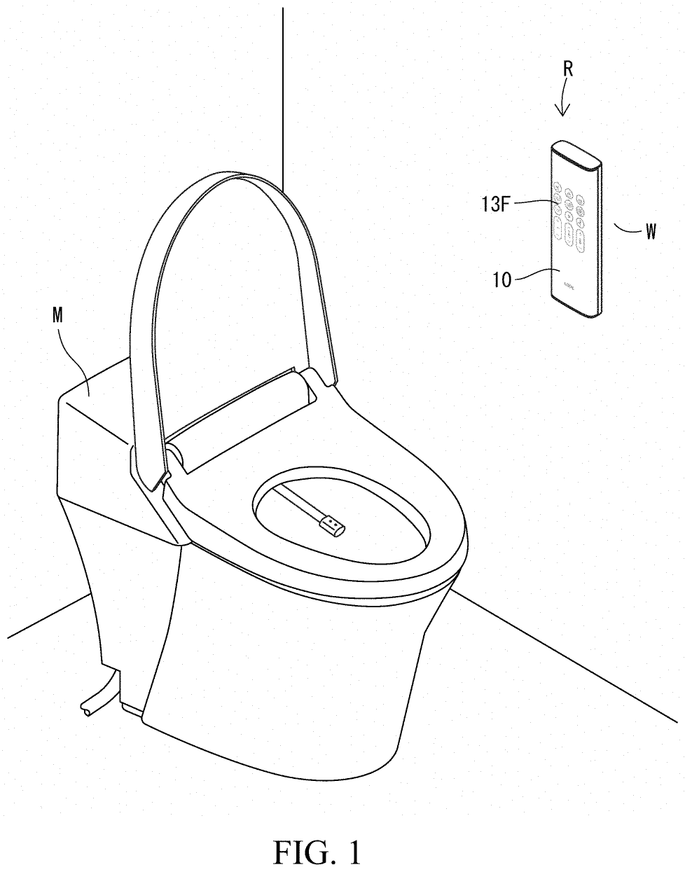

A toilet remote controller (referred to as remote controller R) transmits an operation signal to a functional device provided in a toilet device M by radio. The remote controller R includes a main body 10. The main body 10 can be used in either a state where it is attached on a mounting surface W in a toilet room or a state where it is detached from the mounting surface W. In the following description, the upper side (upper side in FIG. 1) of the main body 10 in the state of being attached in the toilet room is referred to as an upper side, the lower side is referred to as a lower side, the indoor side is referred to as a front side, and the side opposite to the indoor side is referred to as a back side, in each component member.

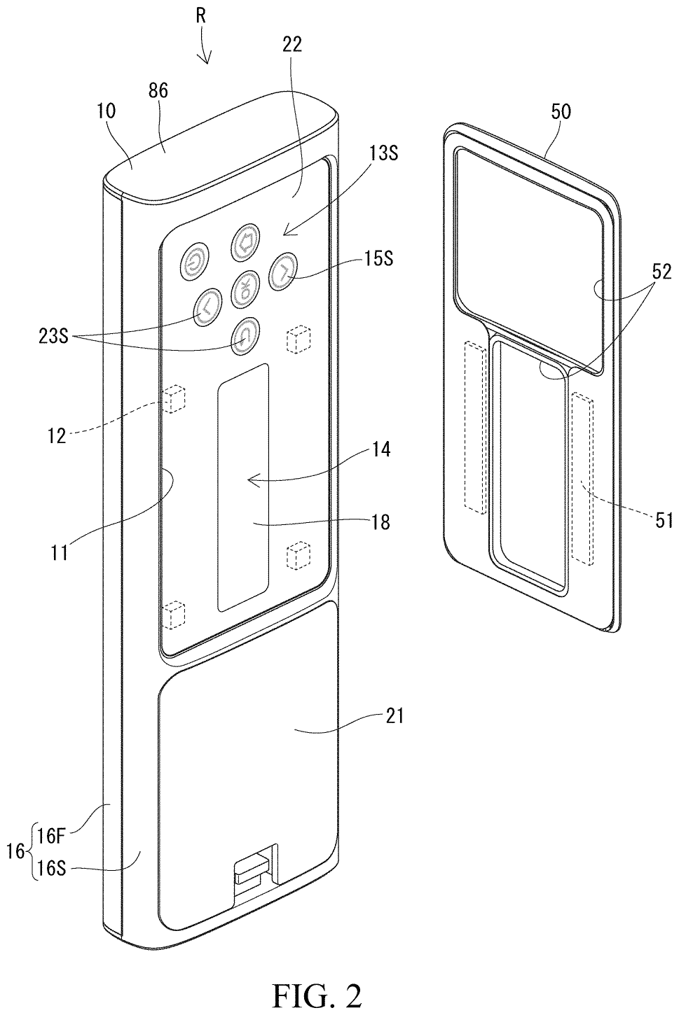

On the back surface of the main body 10, there is provided a recessed portion 11 into which an adapter 50 and a holder are fitted (see FIG. 2). The adapter 50 and the holder are manufactured as separate members from the main body 10.

The adapter 50 includes magnets 51. The adapter 50 is fixed to the back surface of the main body 10 by adhesion or the like. The main body 10 with the adapter is attachable to and detachable from the mounting surface W having a ferromagnetic plate. The adapter 50 is formed with an opening 52 that exposes a second operation unit 13S and a display unit 14 to be described later. Thereby, the operation of the second operation unit 13S can be performed without any trouble even in the main body 10 with the adapter.

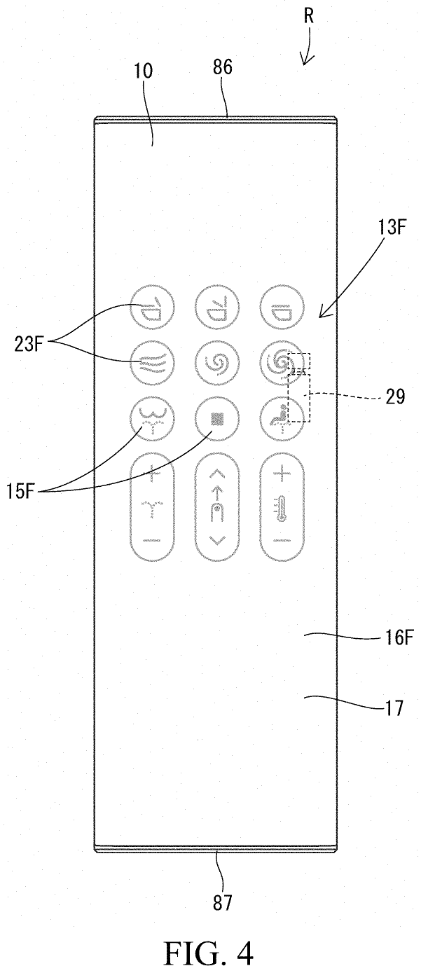

The front and back surfaces of the main body 10 are substantially rectangular. The main body 10 has a lengthwise long shape having a length dimension larger than a width dimension. The width dimension is a length dimension in the lateral direction of the front and back surfaces which extend lengthwise long. The length dimension is a length dimension in the longitudinal direction of the front and back surfaces which extend lengthwise long. The width dimension is a dimension in the left-and-right direction in FIG. 4. The length dimension is a dimension in the up-and-down direction in FIG. 4. The main body 10 includes a first operation unit 13F, the second operation unit 13S, and the display unit 14, each for operating the toilet device M.

The first operation unit 13F is provided on the front surface of the main body 10 (see FIG. 4). The first operation unit 13F is an operation unit for performing operations with relatively high frequency. The operations performed by the functional device by the operation of the first operation unit 13F are, for example, toilet flushing, shower, toilet seat and toilet lid opening/closing operation, hot air drying, washing strength adjustment, nozzle position adjustment, and various-temperature adjustment.

The first operation unit 13F is operated with the main body 10 in a lengthwise long posture. The first operation unit 13F is provided in the central region in the longitudinal direction of the main body 10. The first operation unit 13F can be operated with a thumb by holding the main body 10 with one hand.

The first operation unit 13F includes a plurality of first operation switches 15F for transmitting an operation signal to the functional device which performs the above operations. The first operation switches 15F are each an electrostatic switch that detects that a user has touched a desired first operation switch 15F with a finger. When the first operation switch 15F detects the touch of a finger in the state where the main body 10 is in a lengthwise long posture, an operation signal corresponding to the first operation switch 15F touched by the finger is transmitted to the toilet device M.

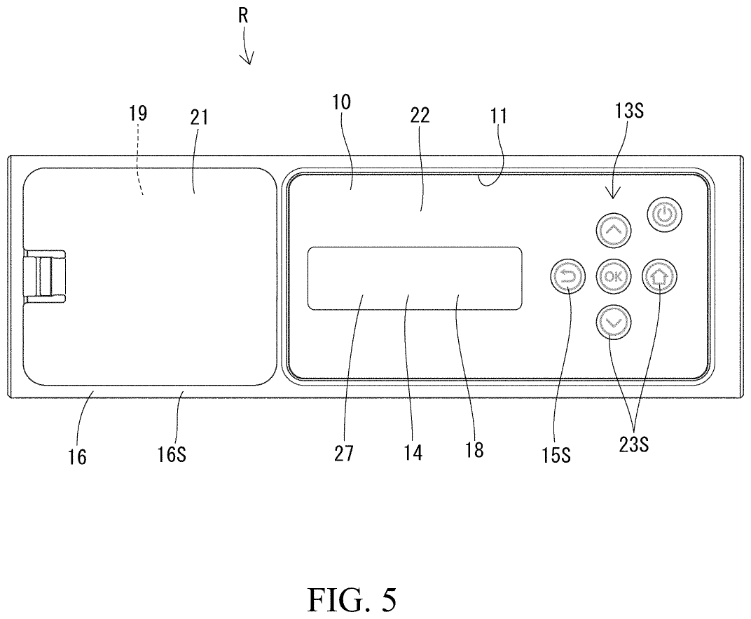

The second operation unit 13S and the display unit 14 are provided on the back surface of the main body 10 (see FIG. 5). The second operation unit 13S is operated with the main body 10 in a laterally long posture. The second operation unit 13S can be operated by holding the main body 10 with both hands. The second operation unit 13S is an operation unit for performing operations that are less frequent than the first operation unit 13F. The operations performed by the operation of the second operation unit 13S are various settings such as ON/OFF settings of power saving and automatic cleaning, and time settings, and ON/OFF of the power of the main body 10.

The second operation unit 13S includes a plurality of second operation switches 15S for transmitting an operation signal to the functional device which performs the above operations. The second operation switches 15S are each a push-type switch that reacts when a user pushes a desired second operation switch 15S.

The display unit 14 displays the setting state set by the second operation unit 13S.

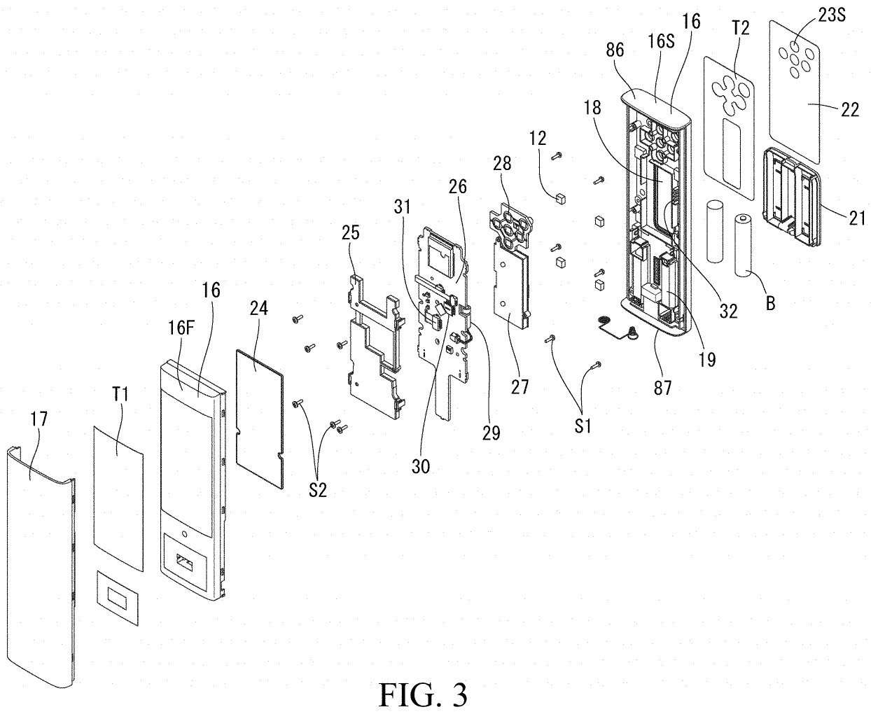

As shown in FIG. 3, the main body 10 includes a case 16 that accommodates electrical components therein. The case 16 is made of synthetic resin (for example, ABS resin). The case 16 includes a first case 16F that constitutes the front surface of the main body 10, and a second case 16S that constitutes the back surface of the main body 10. The first case 16F and the second case 16S are fixed by screws S1.

A cover 17 having light permeability is attached to the front surface of the first case 16F. The cover 17 is affixed to the first case 16F with a double-sided tape T1. The cover 17 is transparent. Pictograms 23F indicating the positions and the functions to be operated of the first operation switches 15F are printed on the back surface of the cover 17. The pictograms 23F are seen through the front side of the cover 17. The pictograms 23F each include a pattern 81 indicating the content of the operation and a frame 82 surrounding the pattern 81. The frame 82 is circular.

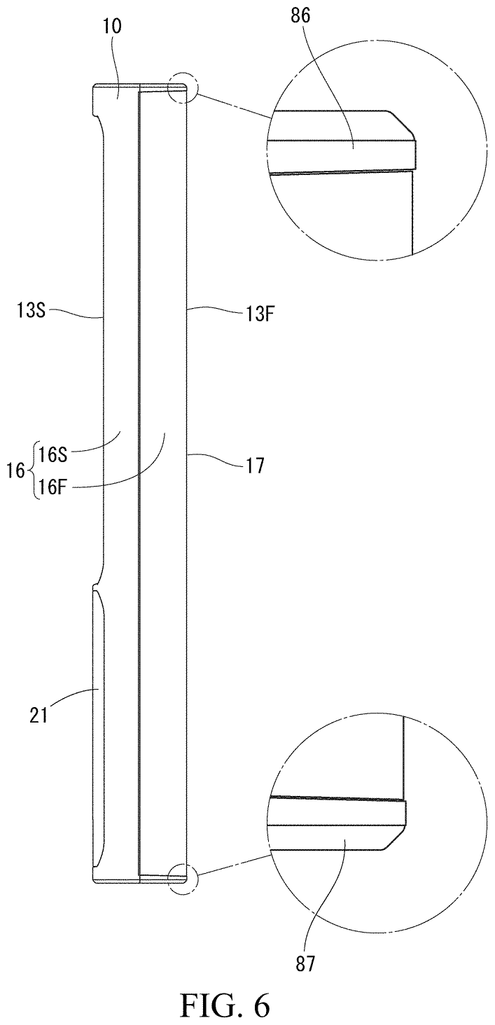

As shown in FIG. 3, the second case 16S includes an upper wall portion 86 that covers the upper side of the upper surface of the first case 16F, and a lower wall portion 87 that covers the lower side of the lower surface of the first case 16F. The upper wall portion 86 and the lower wall portion 87 both have a flat plate shape. As shown in FIG. 6, the front side edges of the upper wall portion 86 and the lower wall portion 87 protrude to the front side beyond the front surface of the cover 17. The upper wall portion 86 and the lower wall portion 87 correspond to a protection portion.

The second case 16S includes a protection panel 18 that is included in the display unit 14. The second case 16S includes a battery storage unit 19 that stores a battery B. A battery cover 21 is detachably attached to the battery storage unit 19. A nameplate 22 is affixed to the back surface of the second case 16S by a double-sided tape T2. The nameplate 22 is provided with a plurality of pictograms 23S that are included in the second operation switches 15S.

Inside the case 16, an electrostatic substrate 24, a frame 25, a circuit board 26, a liquid crystal display 27, and a rubber sheet 28 are accommodated. The electrostatic substrate 24, the frame 25, the circuit board 26, and the liquid crystal display 27 are overlapped in the front-and-back direction.

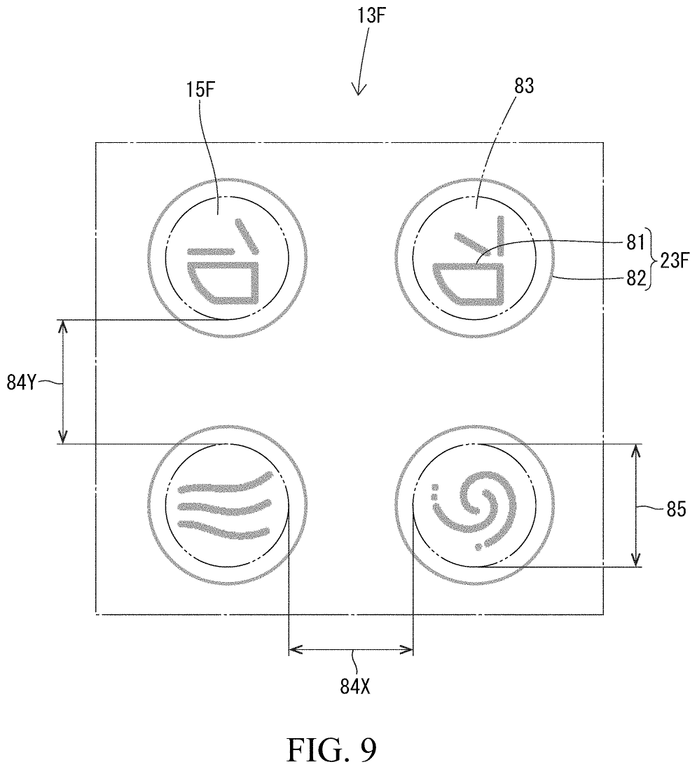

The electrostatic substrate 24 constitutes an electrostatic switch. As shown in FIG. 9, the electrostatic substrate 24 includes detection regions 83 corresponding to the respective pictograms 23F. The detection regions 83 are arranged in line in the longitudinal and lateral directions. Each detection region 83 is located within the frame 82 of the pictogram 23F. The detection region 83 is a circular region that is slightly smaller than the frame 82. The detection regions 83 are arranged in line in the longitudinal and lateral directions so as to correspond to the pictograms 23F. Spaces 84Y between the detection regions 83 adjacent in the longitudinal direction are equal to one another. Spaces 84X between the detection regions 83 adjacent in the lateral direction are equal to one another. The spaces 84X and 84Y between the adjacent detection regions 83 refer to the smallest spaces in the spaces between the adjacent detection regions 83. The spaces 84Y in the longitudinal direction and the spaces 84X in the lateral direction between the adjacent detection regions 83 are larger than diameter dimensions 85 of the detection regions 83.

The electrostatic substrate 24 detects touch of a finger on the detection region 83. On the circuit board 26, there is mounted a CPU 30 including an arithmetic device, a control device and the like. The CPU 30 corresponds to a control unit that transmits an operation signal to the toilet device M. The CPU 30 calculates the position coordinates of the detection region 83 where the touch is detected. The CPU 30 determines that the pictogram 23F of the touched detection region 83 has been operated. The CPU 30 transmits an operation signal corresponding to the touched pictogram 23F to the toilet device M.

The electrostatic capacitance sensors of the first operation switches 15F are mutual capacitance sensors. The mutual capacitance sensor generates an electric field using a transmission electrode and a reception electrode, and detects a change in the electric field between the transmission and reception electrodes. The mutual capacitance sensor is less easily affected by liquid because the electric field hardly changes even if the liquid adheres to the surface.

The frame 25 has an insulating property. The circuit board 26 is fixed to the second case 16S with screws S2. The liquid crystal display 27 is included in the display unit 14.

The rubber sheet 28 is arranged at a position corresponding to the second operation unit 13S. The rubber sheet 28 is made of an elastic material such as silicon rubber. When the pictogram 23S of the second operation unit 13S is pushed and operated, the rubber sheet 28 is elastically deformed. Thereby, the pushing operation of the second operation unit 13S is tactilely notified to a user.

An acceleration sensor 31 is mounted on the circuit board 26. The acceleration sensor 31 detects the posture of the main body 10 in the three-dimensional direction. The acceleration sensor 31 corresponds to a posture detection sensor.

The CPU 30 determines whether the posture of the main body 10 detected by the acceleration sensor 31 is the posture when a user operates the first operation unit 13F (referred to as first posture) or the posture when a user operates the second operation unit 13S (referred to as second posture).

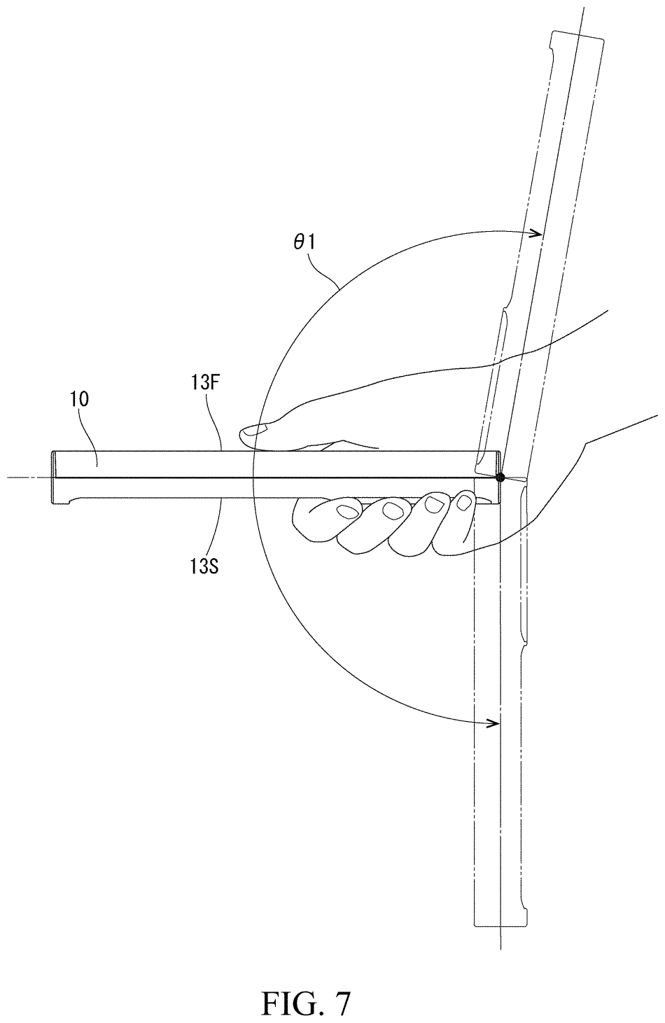

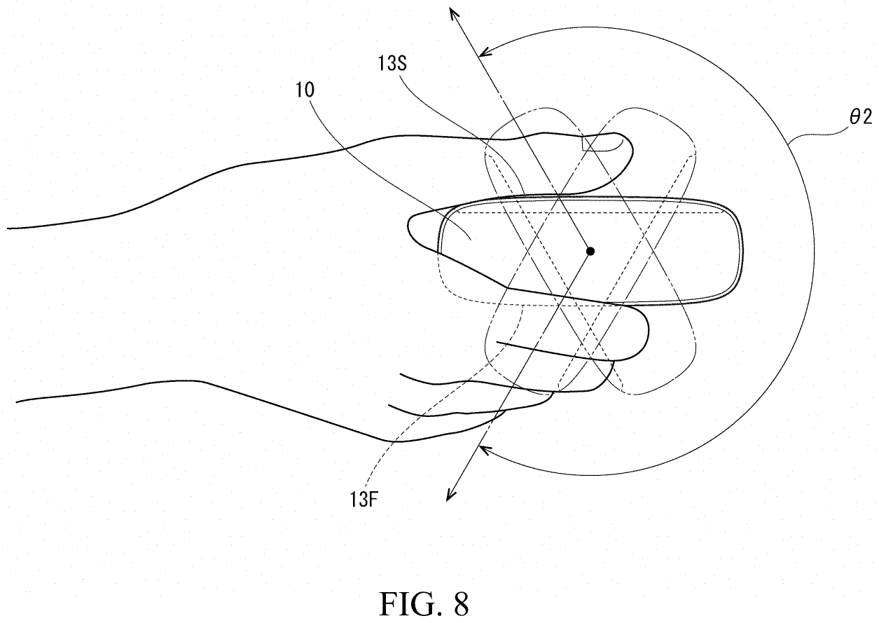

When the tilt angle of the main body 10 in the longitudinal direction is within a predetermined angle θ1 as shown in FIG. 7, the CPU 30 determines that the main body 10 is in the first posture. When the tilt angle of the main body 10 in the lateral direction is within a predetermined angle θ2 as shown in FIG. 8, the CPU 30 determines that the main body 10 is in the second posture.

When it is determined that the main body 10 is in the first posture, the CPU 30 transmits an operation signal of the first operation unit 13F to the toilet device M. When it is determined that the main body 10 is in the second posture, the CPU 30 does not transmit an operation signal of the first operation unit 13F to the toilet device M. Thus, even when a finger of a user unintentionally touches the first operation switch 15F of the first operation unit 13F during the operation of the second operation unit 13S, the operation signal of the first operation unit 13F is not transmitted to the toilet device M. Therefore, it is possible to prevent an erroneous operation unintended by the user. When a finger touches multiple first operation switches 15F at the same time, the circuit board 26 does not transmit any operation signal of the first operation unit 13F to the toilet device M regardless of the posture of the main body 10.

A vibration motor 29 is electrically connected to the circuit board 26. The vibration motor 29 corresponds to a vibration source. As shown in FIG. 3, the vibration motor 29 is accommodated in a motor accommodating portion 32 provided in the second case 16S. As shown in FIG. 4, the vibration motor 29 is arranged in the central region in the longitudinal direction of the main body 10. The vibration motor 29 is arranged at a position overlapping the pictograms 23F of the first operation switches 15F in the front-and-back direction. The vibration motor 29 is provided on the right side when the front surface of the main body 10 is viewed from the front. The vibration motor 29 is located on the side close to a palm when a right-handed person holds the main body 10 with the right hand. The CPU 30 activates the vibration motor 29 by the operation of the first operation unit 13F.

According to some embodiments, the following effects can be obtained.

The remote controller R includes the main body 10, the first operation switches 15F, and the circuit board 26. The main body 10 transmits an operation signal to the toilet device M. The first operation switches 15F are electrostatic switches provided on the front surface of the main body 10. The circuit board 26 is provided in the main body 10. The CPU 30 of the circuit board 26 transmits an operation signal corresponding to the operation of the first operation switch 15F to the toilet device M. According to this configuration, since the operation signal can be transmitted to the toilet device M simply by touching the front surface of the main body 10, it is not necessary to form irregularities on the front surface of the main body 10, and the design of the main body 10 can be improved.

The main body 10 includes the vibration motor 29 that is activated by the operation of the first operation switch 15F. According to this configuration, since the main body 10 vibrates by the operation of the first operation switch 15F, a user can tactilely know the operation of the first operation switch 15F.

The electrostatic capacitance sensors of the first operation switches 15F are mutual capacitance sensors. According to this configuration, it is possible to prevent an erroneous detection due to adhesion of water droplets, and thus it is possible to prevent an erroneous operation of the toilet device M caused by water adhering to the front surface of the main body 10.

The first operation switches 15F include the plurality of detection regions 83. The first operation switch 15F detects touch on the detection region 83 and recognizes the position of the detection region 83 where the touch is detected. The detection regions 83 are arranged in line on the front surface of the main body 10. The spaces 84X and 84Y in the arrangement directions between the adjacent detection regions 83 are larger than the diameter dimensions 85 of the adjacent detection regions 83. According to this configuration, the adjacent detection regions 83 are sufficiently separated as compared to the sizes of the detection regions 83, so that it is difficult to touch multiple detection regions 83 at the same time.

The main body 10 includes the cover 17 having light permeability on the front surface. According to this configuration, the patterns 81 relating to the operations of the first operation switches 15F can be provided on the inner surface of the cover 17 having light permeability. Therefore, it is possible to prevent the patterns 81 from fading or disappearing due to touch of a finger.

The case 16 of the main body 10 includes the upper wall portion 86 and the lower wall portion 87 that protrude to the front side beyond the front surface. According to this configuration, for example, even when the main body 10 is temporarily placed in some place with the front surface of the main body 10 facing downward, the front surface of the main body 10 does not easily contact the place directly, so that the front surface of the main body 10 is less likely to be damaged.

The CPU 30 transmits an operation signal of the first operation switch 15F to the toilet device M when the main body 10 is in a predetermined posture, and does not transmit an operation signal of the first operation switch 15F to the toilet device M when the main body 10 is not in a predetermined posture. According to this configuration, even when the first operation switch 15F is touched when the main body 10 is not in a predetermined posture, an operation signal is not transmitted to the toilet device M. Therefore, it is possible to prevent an unintended operation signal from being transmitted even when, for example, a finger touches the first operation switch 15F when carrying the main body 10.

A main body 10 of a remote controller R of some embodiments is held by a holder 90 fixed to the mounting surface W by fixing means that is freely selected. Magnets 12 built in the main body 10 attract magnets 91 provided in the holder 90. The main body 10 is held by the holder 90 by the magnetic attractive force when the recessed portion 11 on the back surface is fitted to the holder 90.

When the mounting surface W does not have ferromagnetism, the holder 90 can be fixed to the mounting surface 59 with a bolt (not shown) or the like. The holder 90 is fixed to the mounting surface W in such a manner that the main body 10 assumes a lengthwise long posture. The state where the main body 10 is fixed to the mounting surface W is the first posture. The first operation unit 13 can be operated with the main body 10 being fixed to the mounting surface W.

The present disclosure is not limited to the embodiments described with reference to the above description and drawings. For example, the following embodiments are also included in the technical scope of the present disclosure.

In some embodiments, the electrostatic capacitance sensors of the first operation switches 15F are mutual capacitance sensors. The present disclosure is not limited to this, and the electrostatic capacitance sensors of the first operation switches F may be self-capacitance sensors.

In some embodiments, the size and arrangement of the detection regions 83 are exemplified. The present disclosure is not limited to this, and the size and arrangement of the detection regions can be changed as appropriate.

In some embodiments, the detection regions 83 are circular. The present disclosure is not limited to this, and the detection regions may have any shape. In this case, the maximum dimension of each detection region in the arrangement direction is not always the diameter dimension of the detection region. For example, when the detection regions are rectangular, the maximum dimension in the longitudinal direction is the dimension of the detection region in the longitudinal direction, and the maximum dimension in the lateral direction is the dimension of the detection region in the lateral direction. For example, when the detection regions are triangle with a sharp upper end, the maximum dimension in the longitudinal direction is the height dimension of the detection region, and the maximum dimension in the lateral direction is the dimension of the lower end of the detection region.

In some embodiments, the acceleration sensor 31 is used as the posture detection sensor. The present disclosure is not limited to this, and for example, a gyro sensor may be used as the posture detection sensor.

In some embodiments, the vibration motor 29 is exemplified as the vibration source. The vibration source may, in some embodiments, not be limited to the vibration motor.

In some embodiments, the main body 10 includes the cover 17 having light permeability. The main body may, in some embodiments, not include the cover having light permeability.

In some embodiments, the case 16 of the main body 10 includes the upper wall portion 86 and the lower wall portion 87 that protrude to the front side beyond the front surface. The main body may, in some embodiments, not necessarily include the upper wall portion and the lower wall portion.

In some embodiments, the main body 10 includes the second operation unit 13S. The main body may, in some embodiments, not include the second operation unit.

In some embodiments, the electrostatic switch is provided on the front surface of the main body 10. The present disclosure is not limited to this, and the front surface of the main body may be provided with a push-type switch in addition to the electrostatic switch.

In some embodiments, whether or not an operation signal of the first operation unit 13F is transmitted to the toilet device M is controlled based on the posture of the main body 10. The present disclosure is not limited to this, and an operation signal of the first operation unit may be transmitted to the toilet device regardless of the posture of the main body.

What is claimed is:

1. A toilet remote controller comprising:
a main body;
an electrostatic switch provided on a front surface of the main body; and
a control unit that is provided in the main body and configured to transmit an operation signal corresponding to an operation of the electrostatic switch to a toilet device.

2. The toilet remote controller of claim 1, wherein the main body includes a vibration source that is activated by the operation of the electrostatic switch.

3. The toilet remote controller of claim 1, wherein an electrostatic capacitance sensor of the electrostatic switch is a mutual capacitance sensor.

4. The toilet remote controller of claim 1,
wherein the electrostatic switch includes multiple detection regions, the electrostatic switch being configured to detect touch on the detection region and recognize a position of the detection region where the touch is detected,
wherein the detection regions are arranged in line on the front surface; and
wherein a space between the adjacent detection regions in an arrangement direction is larger than a maximum dimension of each of the adjacent detection regions in the arrangement direction.

5. The toilet remote controller of claim 1, wherein the main body includes a cover having light permeability on the front surface.

6. The toilet remote controller of claim 1, wherein a case of the main body includes a protection portion that protrudes to a front side beyond the front surface.

7. The toilet remote controller of claim 1, wherein the control unit is configured to transmit the operation signal of the electrostatic switch to the toilet device when the main body is in a first posture, and is configured to not transmit the operation signal of the electrostatic switch to the toilet device when the main body is in a second posture different from the first posture.

8. The toilet remote controller of claim 7, wherein the main body is fixed to a wall by a holder in the first posture.

9. The toilet remote controller of claim 7, wherein an operation unit operable in the second posture is provided on a back surface of the main body.

10. The toilet remote controller of claim 1, wherein the main body includes a posture detection sensor that detects a posture of the main body in at least two axis directions.
